(19) United States
(12) Patent Application Publication
(10) Pub. No.: US 2010/0225216 A1
(43) Pub. Date: Sep. 9, 2010

(54) Switch complementary equal brightness LED lamp

(76) Inventor: Han-Ming LEE, Hsin Chu City (TW)

Correspondence Address: Han-Ming Lee, P.O. BOX 7-820, HSIN CHU CITY, TAIPEI, TW

(21) Appl. No.: 12/381,078

(22) Filed: Mar. 9, 2009

(51) Int. Cl. H01J 7/44

(52) U.S. Cl. 313/1

(57) ABSTRACT

The present invention relates to a switch complementary equal brightness LED lamp, comprising the silicon lamp cover, upper lamp housing, two conducting plates, lower lamp housing, chip cup lamp seat, chips, and conducting wires. The main improvement including: the chip cup lamp seat is provided with a plurality of chip cups so that a single large power chip can be replaced by a plurality of small power chips of equal power to be inserted, two conducting plates are used to control the chips to extinguish the lamp in a cyclic manner and maintain equal LED illumination, and the lower lamp housing, insulator, two conducting plates, upper lamp housing, silicon lamp housing are integrated to create a light source with overall equal brightness and extend the service life of individual chips.

### BACKGROUND OF THE INVENTION

Presently, the light sources are generally traditional fluorescent lamps or bulbs, which carry forward the design of traditional glass lamp housing in which two conducting pins are bridged to the Tungsten wires to generate light and heat; the fluorescent lamps are glass light tubes provided with fluorescent powder to generate light source. In recent years, with the innovation of the electronic industry and the ever-growing awareness of environmental protection, the fluorescent lamps are gradually replaced by the energy saving LED lamps. However, the high heat effect of LED lamps due to being energized for a long period of time to give off light may still cause the chips in the LED to decay early and therefore shorten their service life, making it necessary to improve and perfect the structure of LED lamps.

### SUMMARY OF THE INVENTION

The primary purpose of the present invention is to provide a switch complementary equal brightness LED lamp and in particular to one comprising the silicon lamp cover, upper lamp housing, two conducting plates, insulator, lower lamp housing, chip cup lamp seat, chips, and conducting wires to create a light source with overall equal brightness and extend the service life of individual chips.

The secondary purpose of the present invention is to provide a switch complementary equal brightness LED lamp, wherein the chip cup lamp seat is provided with a plurality of chip cups so that a single large power chip can be replaced by a plurality of small power chips of equal power to be inserted.

Another purpose of the present invention is to provide a switch complementary equal brightness LED lamp, in particular one wherein the two conducting plates are used to control the chips to extinguish the lamp in a cyclic manner and maintain equal LED illumination.

One more purpose of the present invention is to provide a switch complementary equal brightness LED lamp, wherein the lower lamp housing, insulator, two conducting plates, upper lamp housing, and silicon lamp cover can be assembled and sealed into one in turn rapidly.

### BRIEF DESCRIPTION OF THE DRAWINGS

FIG. 1 is a 3D diagram of the present invention.

FIG. 2 is a schematic diagram of the components of the present invention.

FIG. 3 is a combined cross-section 3D diagram of the present invention.

FIG. 4 is a 3D diagram of the chip that illuminates of the present invention.

FIG. 5 is a schematic of the two conducting plates of the present invention controlling the chips to illuminate in a cyclic manner.

FIG. 6 is a schematic of the square chip cups of the present invention reflected into fully straight light rays.

FIG. 7 is a schematic of the semi-conductor lamp of the present invention installed in the embedded lamp.

FIG. 8 is a semi-conductor lamp of the present invention installed as the embedded lamp.

### DELTAILED DESCRIPTION OF THE PREFERRED EMBODIMENT

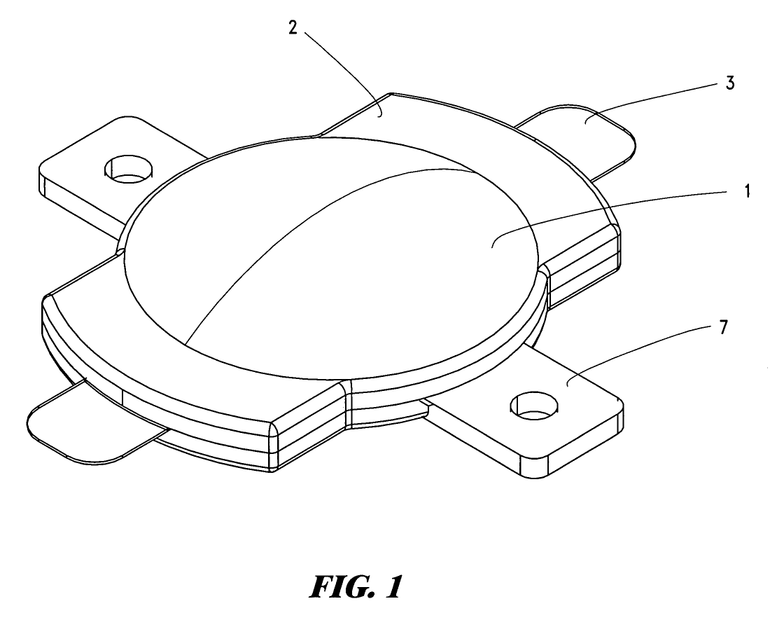

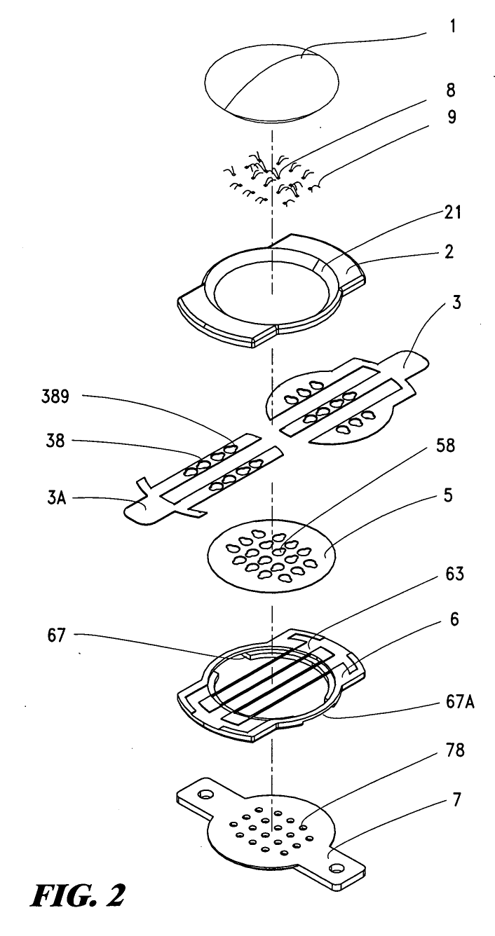

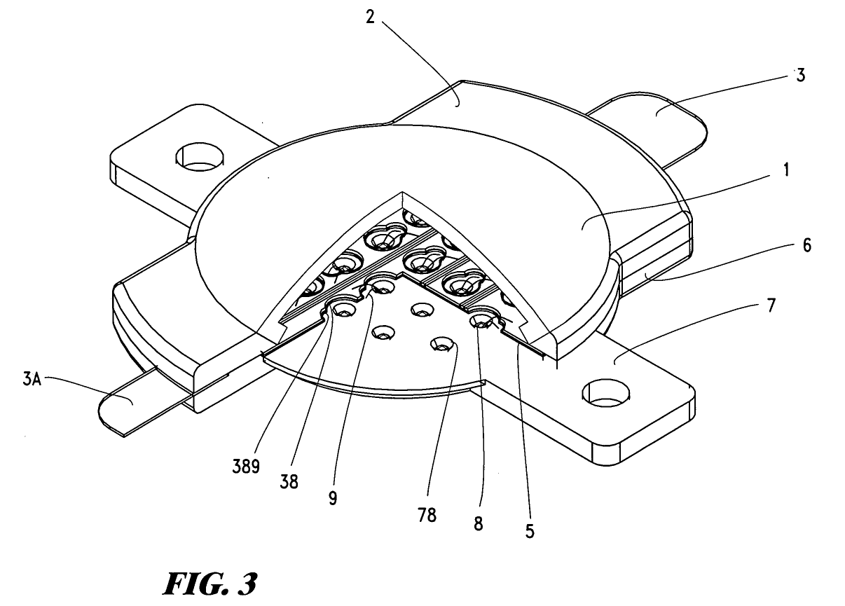

Please refer to FIGS. 1 through FIGS. 3, the present invention relates to a switch complementary equal brightness LED lamp, comprising the silicon lamp cover 1, upper lamp housing 2, two conducting plates 3 and 3A, insulator 5, lower lamp housing 6, chip cup lamp seat 7, chips 8, and conducting wires 9; the silicon lamp cover 1 is a semi-round cover made of transparent material; the upper lamp housing 2 is a round disk made of insulating material with a concave ring hole 21 provided at the top for holding the outer ring beneath the silicon lamp cover 1 into place; the two conducting plates 3 and 3A are two front crossing plates that project in relative to each other and in the round shape, the front crossing plate surface of which are provided with a plurality of taper holes 38, which are provided with semi-round taper concave grooves 389 and two plate pieces project from the front end and back end of the plates; the insulator 5 is a round piece in relative to conducting plates 3 and 3A, the round plate surface is provided with through holes 58 in relative to the taper holes 38 on the conducting plate 3 for attaching to beneath the conducting plates 3 and 3A; the lower lamp housing 6 is a lamp housing made of insulating material in relative to upper lamp housing 2, on top of which is a concave groove seat 63 for the installation of the two conducting plates 3 and 3A and the extension hole down from the centerline is provided with the left and right concave grooves 67 and 67A; the chip cup lamp seat 7 is a round with two plate pieces projecting from the left and the right, the round plate surface is provided with a plurality of chip cups 78 in relative to the taper holes 38 on the two conducting plates 3 and 3A, a positioning hole for screwing into place is provided for each of the two plate pieces, the two plate pieces are provided for being embedded into the left and right concaves groove 67 and 67A beneath the lower lamp housing 6; the chips 8 are lighting semi-conductor chips for being embedded into a plurality of chip cups 78; the conducting wires 9 are made of conducting material, connected to the chips 8 on one end and the two conducting plates 3, 3A or chip cup lamp seat 7 on the other end.

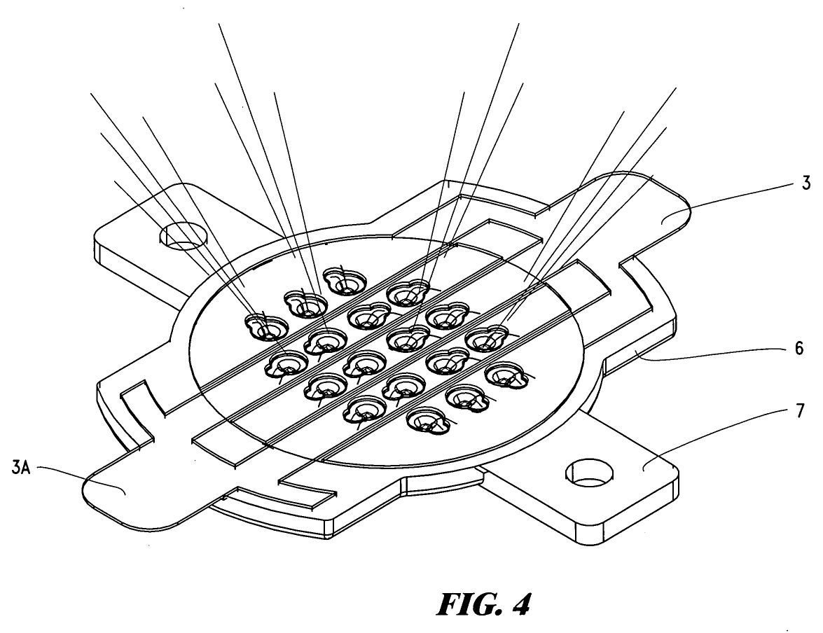

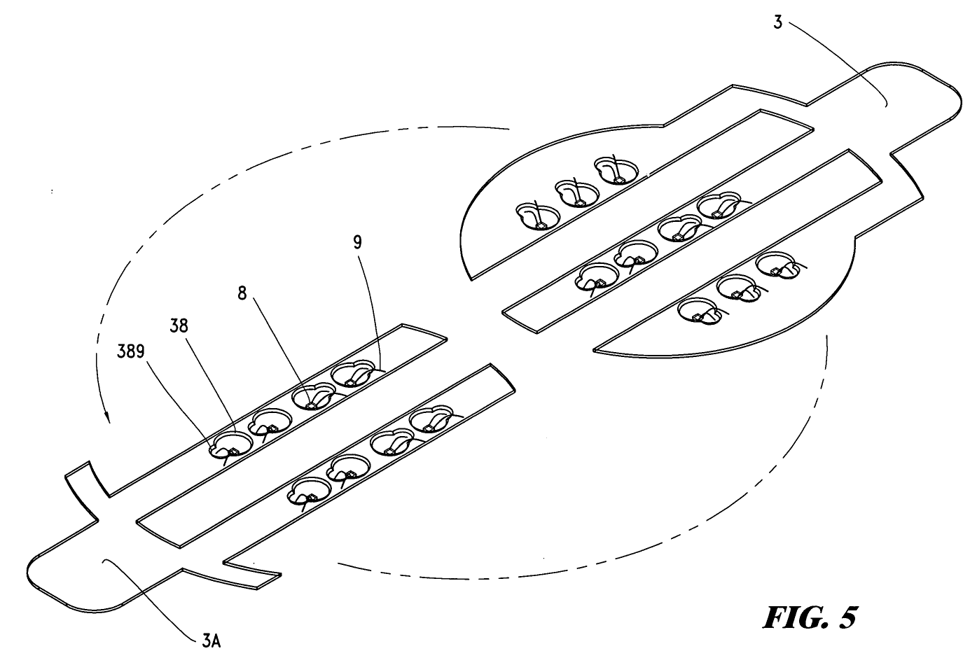

Please refer to FIGS. 4 through FIGS. 5 for one embodiment of this invention. The chip cup lamp seat 7 is provided with a plurality of chip cups 78 for the insertion of a single large power chip replaced by a plurality of small power chips 8 of equal power so that the lower lamp housing 6, insulator 5, two conducting plates 3 and 3A, upper lamp housing 2, and silicon lamp cover 1 can be integrated into one with the two conducting plates 3 and 3A connected to chips 8 to control the switch complementary equal brightness operation through IC and enable chips 8 to extinguish the lamp in a cyclic manner so that each chip will not operate continuously at high temperature. If the other end of the conducting wires 9 connects the chip cup lamp seat 7 through the concave grooves 389, it can create the white light effect so as to create a light source with overall equal brightness and extend the service life of individual chips.

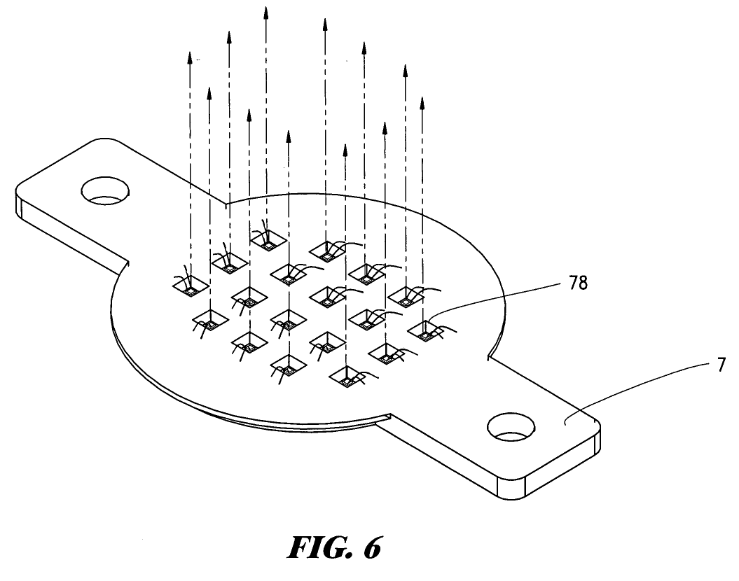

Please refer to FIG. 6 for another embodiment of the present invention. The chip cups 78 of the chip cup lamp seat 7 of this invention may also be square for the light source of the inserted chips 8 to be reflected as fully straight light rays so as to generate equal brightness of long distance panel.

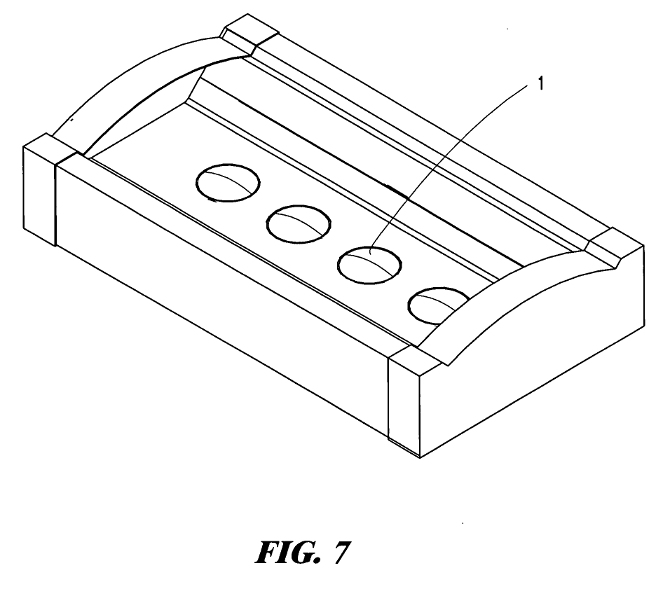

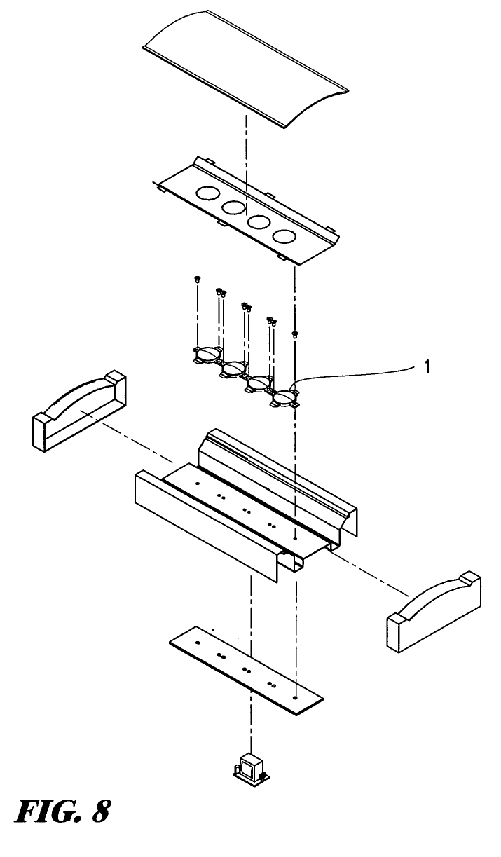

Please refer to FIGS. 7 and FIGS. 8 for one more embodiment of the present invention. The switch complementary equal brightness LED lamp of the present invention can be designed to be installed in an ordinary equal brightness embedded fluorescent lamp to fully replace the traditional high energy consumption fluorescent lamps, significantly extend the service life of the lamps and reduce the power consumption.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changers in the forms and details of the device illustrated and in its operation can be made by those skilled in the art without departing in any way from the spirit of the present invention.

I claim:

1. A switch complementary equal brightness LED lamp, comprising the silicon lamp cover, upper lamp housing, two conducting plates, insulator, lower lamp housing, chip cup lamp seat, chips, and conducting wires, wherein:
The silicon lamp cover is a semi-round cover made of transparent material;
The upper lamp housing is a round disk made of insulating material with a concave ring hole provided at the top for holding the outer ring beneath the silicon lamp cover into place;
The two conducting plates are two front crossing plates that project in relative to each other and in the round shape, the front crossing plate surface of which are provided with a plurality of taper holes, and two plate pieces project from the front end and back end of the plates;
The insulator is a round piece in relative to conducting plates, the round plate surface is provided with through holes in relative to the taper holes on the conducting plate for attaching to beneath the conducting plates;
The lower lamp housing is a lamp housing made of insulating material in relative to upper lamp housing, on top of which is a concave groove seat for the installation of the two conducting plates and the extension hole down from the centerline is provided with the left and right concave grooves;
The chip cup lamp seat is a round with two plate pieces projecting from the left and the right, the round plate surface is provided with a plurality of chip cups in relative to the taper holes on the two conducting plates, a positioning hole for screwing into place is provided in each of the two plate pieces, the two plate pieces are provided for being embedded into the left and right concave grooves beneath the lower lamp housing;
The chips are lighting semi-conductor chips for being embedded into a plurality of chip cups;
The conducting wires are made of conducting material, connected to the chips on one end and the two conducting plates or chip cup lamp seat on the other end;
Through the above structure, the chip cup lamp seat is provided with a plurality of chip cups for the insertion of a plurality of small power chips, two conducting plates are connected to the chips to control the switch complementary equal brightness operation through IC and enable the chips to extinguish the lamp in a cyclic manner so that each chip will not operate continuously at high temperature so as to create a light source with overall equal brightness and extend the service life of individual chips.

2. The switch complementary equal brightness LED lamp according to claim 1, wherein the taper holes of the conducting plate are provided with semi-round taper concave grooves for the other end of the conducting wires to connect the chip cup lamp seat to create the white light effect.

3. The switch complementary equal brightness LED lamp according to claim 1, wherein the chip cups of the chip cup lamp seat are square for the light source of the chips inserted to be reflected as fully straight light rays.
